(19) United States
(12) Patent Application Publication
(10) Pub. No.: US 2025/0105771 A1
(43) Pub. Date: Mar. 27, 2025

(54) POWER TOOL INCLUDING DYNAMICALLY CONFIGURABLE MOTOR PARAMETERS

(71) Applicant: MILWAUKEE ELECTRIC TOOL CORPORATION, Brookfield, WI (US)

(72) Inventors: Alejandro M. Damonte Vegas, Glendale, WI (US); Kentez L. Craig, Milwaukee, WI (US)

(21) Appl. No.: 18/899,162

(22) Filed: Sep. 27, 2024

Related U.S. Application Data
(60) Provisional application No. 63/585,655, filed on Sep. 27, 2023.

(51) Int. Cl. H02P 23/00; H02K 7/14; H02K 11/00; H02K 21/16

(52) U.S. Cl. CPC H02P 23/009; H02K 7/145; H02K 11/0094; H02K 21/16; H02P 2207/05

(57) ABSTRACT

A power tool includes a housing and a brushless motor. The brushless motor includes a rotor and a stator and is configured to rotate a motor shaft to rotate a motor shaft to produce an output. The output of the brushless motor is adjustable based on a plurality of selectable field weakening modes. The power tool includes a battery pack receptacle configured to receive a battery pack, a power circuit configured to receive power from the battery pack and supply power to the brushless motor, and an electronic processor electrically connected to the motor, the battery receptacle, and the power circuit. The electronic processor is configured to determine a tool parameter associated with the output of the power tool, and determine a motor parameter based on the determined tool parameter. The motor parameter is associated with one of the plurality of selectable field weakening modes.

### RELATED APPLICATIONS

This application claims the benefit of U.S. Provisional Patent Application No. 63/585,655, filed Sep. 27, 2023, the entire content of which is hereby incorporated by reference.

### FIELD

This disclosure relates to a power tool.

### SUMMARY

Power tools described herein include a housing and a brushless motor supported within the housing. The brushless motor includes a rotor and a stator, and is configured to rotate a motor shaft to produce an output. The output of the brushless motor is adjustable based on a plurality of selectable field weakening modes. The power tool further includes a battery pack receptacle configured to receive a battery pack, a power circuit configured to receive power from the battery pack and supply power to the brushless motor, and an electronic processor electrically connected to the power circuit. The electronic processor is configured to determine a tool parameter associated with the output of the power tool, determine a motor parameter based on the determined tool parameter, the motor parameter being associated with one of the plurality of selectable field weakening modes, and control the brushless motor using the one of the plurality of selectable field weakening modes.

Power tools described herein include a housing and a brushless motor supported within the housing. The brushless motor includes a rotor and a stator and is configured to rotate a motor shaft to produce an output. The output of the brushless motor is adjustable based on a motor parameter. The power tool further includes a battery pack receptacle configured to receive a battery pack, a mode input device disposed on the housing configured to receive a user input indicative of a tool mode, a power circuit configured to supply power to the brushless motor and an electronic processor. The electronic processor is configured to receive a tool mode from the mode input device, determine a commutation profile in response to the tool mode received by the mode input device, determine an adjusted motor parameter based on the commutation profile, and control the brushless motor using the adjusted motor parameter.

Power tools described herein include a housing and a brushless motor supported within the housing. The housing includes a motor housing portion, a front housing portion, a rear housing portion, and a handle extending from the motor housing portion. The brushless motor includes a rotor and a stator and is configured to rotate a motor shaft to produce an output. The output of the brushless motor is adjustable based on a plurality of selectable field weakening modes. The power tool further includes a battery pack receptacle configured to receive a battery pack, a mode input device, an indicator, a power circuit configured to receive power from the battery pack and supply power to the brushless motor, and an electronic processor electrically connected to the power circuit. The mode input device is configured to receive a user input indicative of one of the plurality of selectable field weakening modes. The indicator is configured to provide an indication of the one of the selectable field weakening modes. The electronic processor is configured to determine a tool parameter associated with the output of the power tool, determine a motor parameter based on the determined tool parameter, the motor parameter being associated with one of the plurality of selectable field weakening modes, and control the brushless motor using the one of the plurality of selectable field weakening modes.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Other features and aspects of the disclosure will become apparent by consideration of the following detailed description and accompanying drawings.

### BRIEF DESCRIPTION OF THE DRAWINGS

FIG. 1 is a perspective view of a power tool according to various embodiments described herein.

FIG. 2 is a detail view of a portion of the power tool of FIG. 1 including a mode selection interface according to various embodiments described herein.

FIG. 3 is a detail view of a portion of the power tool of FIG. 1 including an indicator according to various embodiments described herein.

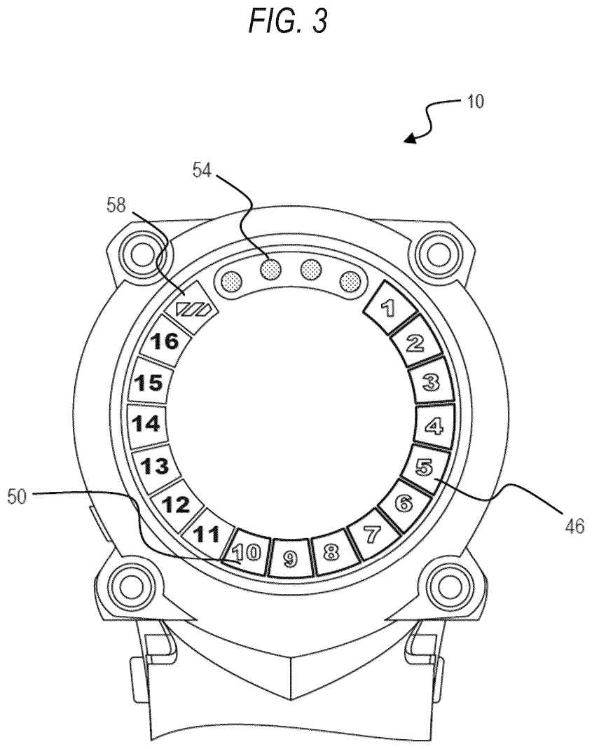

FIG. 4 illustrates a block diagram of a controller for the power tool of FIG. 1 according to various embodiments described herein.

FIGS. 5A and 5B illustrate a sensor board of a brushless DC motor incorporated in the power tool of FIG. 1 according to various embodiments described herein.

FIG. 6 is a graph showing commutation of a brushless motor according to various embodiments described herein.

FIGS. 7 and 8 show flow charts for a method of receiving a user input to control an operational characteristic of a motor of the power tool of FIG. 1 according to various embodiments described herein.

FIG. 9 shows a flow chart for a method of controlling an operational characteristic of a motor of the power tool of FIG. 1 based on a tool parameter according to various embodiments described herein.

FIG. 10 shows a flow chart for a method of determining when to enable automatic control of an operational characteristic of a motor of the power tool of FIG. 1 according to various embodiments described herein.

### DETAILED DESCRIPTION

The power output of a motor of a power tool can be adjusted by changing the amount of power supplied to the motor. For example, pulse width modulation is a common method of converting a voltage supplied by a battery pack to varying apparent voltages, thereby resulting in a variety of motor outputs. However, such an approach is generally limited to the operating characteristics, or parameters, of the motor. Using other methods, such as by adjusting the commutation profile of the motor, the parameters of a brushless direct current motor (BLDC) can be changed. For example, field weakening may be employed to increase the maximum speed of the motor. Field weakening can include modifying a commutation profile of a motor to adjust a conduction angle applied to the motor, a phase advance angle, etc. To that end, a user may adjust both the parameters of the motor and the power applied to the motor in order to have a greater control over the output of the tool. For example, the user may adjust the torque, maximum speed, conduction angle, phase advance angle, etc., of the motor to meet the requirements of a particular task or power tool operational mode. For lower torque tasks where peak power tool performance is not required, the output of the power tool can be somewhat limited. However, for higher torque applications that require greater power, the output of the power tool can be increased (e.g., to maximum levels). The increased output of the power tool can be achieved by, for example, gradually increasing conduction angle and/or phase advance angle as the power demanded for a particular application or mode setting of the power tool increases. As a result, the operation of the power tool is tuned to provide a gradually increasing or scaled output as warranted for the power tool. Such a level of control will provide greater tool efficiency because the power tool is not trying to always operate at a maximum output. The highest performance capabilities of the power tool are thus reserved for the applications and/or operational modes that warrant the highest performance capabilities. Additionally, the performance capabilities of the power tool can be controlled or tuned during use or operation of the power tool, rather than merely being fixed settings that may provide too much power for a particular mode or application.

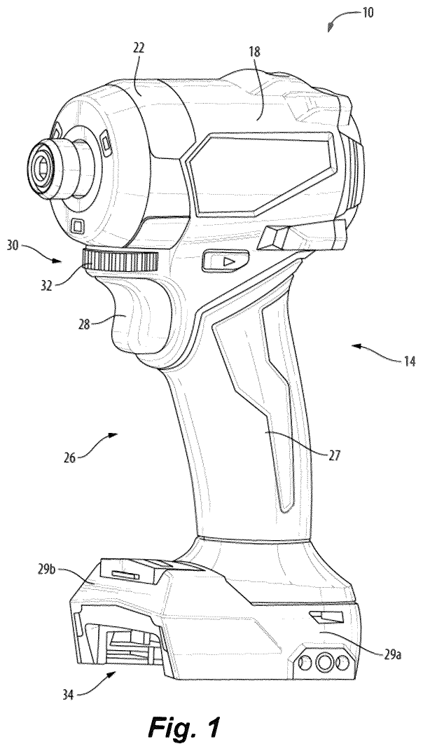

FIG. 1 illustrates a power tool 10 in the form of a rotary impact tool (e.g., an impact driver). The illustrated power tool 10 includes a housing 14 with a motor housing portion 18 enclosing a motor (e.g., a brushless DC motor), a front housing portion or case 22 coupled to the motor housing portion 18 (e.g., by a plurality of fasteners), and a handle portion 26 extending downwardly from the motor housing portion 18. The handle portion 26 includes a grip 27 that can be grasped by a user. A trigger 28 is coupled to a front side of the handle portion 26 and can be actuated by the user to operate the power tool 10. In the illustrated embodiment, the handle portion 26 and the motor housing portion 18 are defined by cooperating clamshell halves 29a, 29b.

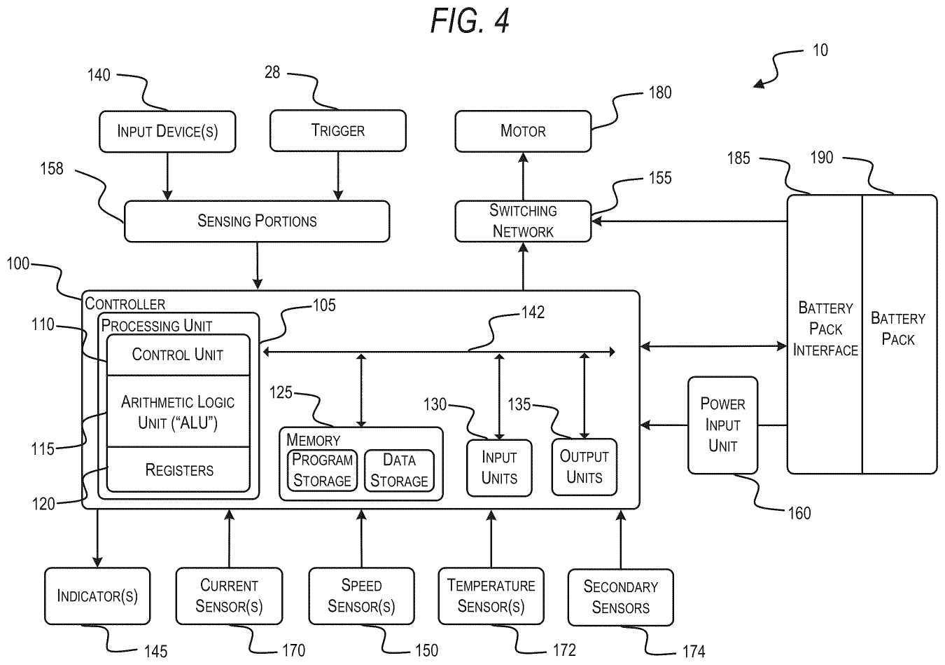

The power tool 10 has a battery pack receptacle 34 located at a bottom end of the handle portion 26. The battery pack receptacle 34 is configured to receive a battery pack (see FIG. 4), which provides power to the motor. In other embodiments, the power tool 10 may include a power cord for electrically connecting the power tool 10 to a source of AC power. As a further alternative, the power tool 10 may be configured to operate using a different power source (e.g., a pneumatic power source, etc.).

In the illustrated embodiment, the power tool 10 includes an input device in the form of a rotary actuator or dial 32. This input device may be used to adjust an operational characteristic of the power tool 10 (e.g., motor torque, motor speed, field weakening, etc.). In the embodiment shown, the dial 32 is located at least partially within a chin portion 30 of the power tool 10, defined between the case 22 and the trigger 28. However, the dial 32 may be situated differently in or on the power tool 10, as will be shown in other embodiments. As illustrated, the dial 32 is accessible from both lateral sides, as well as the front of the power tool 10. This allows the user to rotate the dial 32 about a rotational axis (e.g., using the user's index finger) while grasping the grip 27 of the power tool 10 with the same hand, thus facilitating one-handed, ambidextrous operation of the power tool 10.

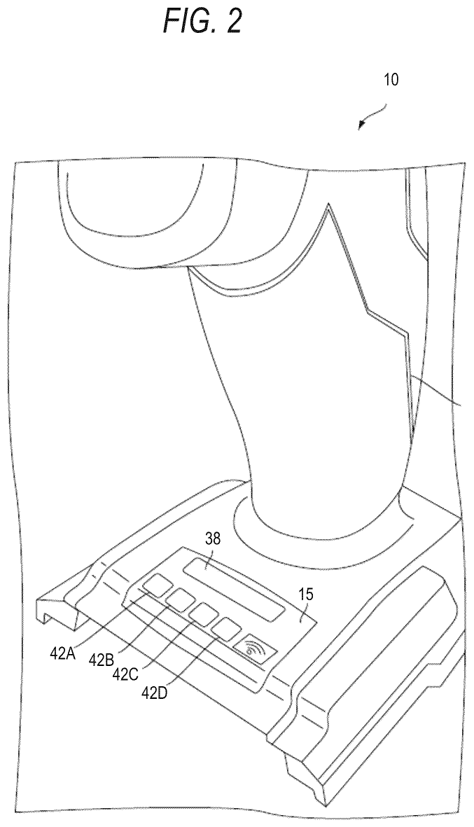

The power tool 10 further includes a mode selection interface 15 and a forward/reverse selector 16. As discussed in further detail below, the mode selection interface 15 may be used to adjust a parameter of the motor (e.g., max speed, output torque, etc.). As shown in FIG. 2, the mode selection interface 15 includes a mode indicator 38 and a plurality of push buttons 42A-42D. The mode indicator 38 displays to the user which mode of operation is currently selected. In the illustrated embodiment, the mode indicator 38 includes LEDs. In other embodiments, the mode indicator 38 may include other type of lighting elements (OLEDs), a display, a rotary knob, an icon, or any other visual or tactile indicator that allows the user to identify the current operation mode for the impact driver 10. A user presses one of the plurality of push buttons 42A-42D to select one of the plurality of operation modes for the impact driver 10. In other words, a press of the push button 42A selects a first mode for the impact driver 10, a press of the push button 42B selects a second mode for the impact driver 10, and so on. In some embodiments, the push buttons 42A-42D may be replaced by a single button that the user presses a certain amount or for a certain duration corresponding with the operating mode. In some embodiments, the push buttons 42A-42D may be replaced by a capacitive touch sensor, a pressure sensor, or any other interactive sensor to allow the user to indicate the preferred mode to set the tool to operate. In some embodiments, the power tool 10 may include additional mode indicators or interactive sensors disposed on the power tool 10.

In some embodiments, the power tool 10 may include a torque indicator 46 located on a side (e.g., a rear side) of the power tool 10. The torque indicator 46 is formed as a ring (e.g., an LED ring). The torque indicator 46 can illuminate different segments of the torque indicator 46 to indicate a torque setting of the power tool 10. A torque setting 50 for the power tool 10 is provided by illuminating a segment of the torque indicator 46. In the illustrated embodiment, the torque setting is a medium value (e.g., 10 of 16). In the illustrated embodiment, a numerical representation is provided to indicate a relative value of the torque setting 50. The power tool 10 can also include a battery pack state-of-charge indicator 54 that is combined with the torque setting indicator 46. In some embodiments, the power tool 10 also includes a mode setting 58 that indicates an operational mode of the power tool 10.

Although the power tool 10 illustrated in FIG. 1 is an impact driver, the power tool 10 can also be a different type of tool, such as, for example, a hammer drill, an impact hole saw, a fastener driver, and the like.

A controller 100 for the power tool 10 is illustrated in FIG. 4. The controller 100 is electrically and/or communicatively connected to a variety of modules or components of the power tool 10. For example, the illustrated controller 100 is connected to indicators 145, a current sensor 170, a speed sensor 150, a temperature sensor 172, secondary sensor(s) 174 (e.g., a voltage sensor, an accelerometer, a torque sensor or torque transducer, etc.), the trigger 28, a power switching network 155, and a power input unit 160.

The controller 100 includes a plurality of electrical and electronic components that provide power, operational control, and protection to the components and modules within the controller 100 and/or power tool 10. For example, the controller 100 includes, among other things, a processing unit 105 (e.g., a microprocessor, an electronic processor, an electronic controller, a microcontroller, or another suitable programmable device), a memory 125, input units 130, and output units 135. The processing unit 105 includes, among other things, a control unit 410, an arithmetic logic unit (“ALU”) 115, and a plurality of registers 120 (shown as a group of registers in FIG. 4) and is implemented using a known computer architecture (e.g., a modified Harvard architecture, a von Neumann architecture, etc.). The processing unit 105, the memory 125, the input units 130, and the output units 135, as well as the various modules connected to the controller 100 are connected by one or more control and/or data buses (e.g., common bus 142). The control and/or data buses are shown generally in FIG. 4 for illustrative purposes. The use of one or more control and/or data buses for the interconnection between and communication among the various modules and components would be known to a person skilled in the art in view of the embodiments described herein.

The memory 125 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 105 is connected to the memory 125 and executes software instructions that are capable of being stored in a RAM of the memory 125 (e.g., during execution), a ROM of the memory 125 (e.g., on a generally permanent basis), or another non-transitory computer readable medium such as another memory or a disc. Software included in the implementation of the power tool 10 can be stored in the memory 125 of the controller 100. The software includes, for example, firmware, one or more applications, program data, filters, rules, one or more program modules, and other executable instructions. The controller 100 is configured to retrieve from the memory 125 and execute, among other things, instructions related to the control processes and methods described herein. In other embodiments, the controller 100 includes additional, fewer, or different components.

The controller 100 drives the motor 180 to rotate a driver in response to a user's actuation of the trigger 28. The driver may be coupled to the motor 180 via an output shaft. Depression of the trigger 28 actuates a trigger switch, which outputs a signal to the controller 100 to drive the motor 180, and therefore the driver. In some embodiments, the controller 100 controls the power switching network 155 (e.g., a FET switching bridge) to drive the motor 180. For example, the power switching network 155 may include a plurality of high side switching elements (e.g., FETs) and a plurality of low side switching elements. The controller 100 may control each FET of the plurality of high side switching elements and the plurality of low side switching elements to drive each phase of the motor 180. For example, the power switching network 155 may be controlled to more quickly deaccelerate the motor 180. In some embodiments, the controller 100 monitors a rotation of the motor 180 (e.g., a rotational rate of the motor 180, a velocity of the motor 180, a position of the motor 180, and the like) via the speed sensors 150. The motor 180 may be configured to drive a gearbox (e.g., a mechanism).

The indicators 145 (e.g., mode indicator 38, torque indicator 46, battery pack state-of-charge indicator 54, etc.) are also connected to the controller 100 and receive control signals from the controller 100 to turn on and off or otherwise convey information based on different states of the power tool 10. The indicators 145 include, for example, one or more light-emitting diodes (LEDs), or a display screen. The indicators 145 can be configured to display conditions of, or information associated with, the power tool 10. For example, the indicators 145 can display information relating to an operational state of the power tool 10, such as a mode or speed setting. The indicators 145 may also display information relating to a fault condition, or other abnormality of the power tool 10. In addition to or in place of visual indicators, the indicators 145 may also include a speaker or a tactile feedback mechanism to convey information to a user through audible or tactile outputs. In some embodiments, the indicators 145 display information related to a braking operation or a clutch operation (e.g., an electronic clutch operation) of the controller 100. For example, one or more LEDs are activated when the controller 100 is performing a clutch operation.

A battery pack interface 185 is connected to the controller 100 and is configured to couple with a battery pack 190. The battery pack interface 185 includes a combination of mechanical (e.g., a battery pack receiving portion) and electrical components configured to and operable for interfacing (e.g., mechanically, electrically, and communicatively connecting) the power tool 10 with the battery pack 190. The battery pack interface 185 is coupled to the power input unit 160. The battery pack interface 185 transmits the power received from the battery pack 190 to the power input unit 160. The power input unit 160 includes active and/or passive components (e.g., voltage step-down controllers, voltage converters, rectifiers, filters, etc.) to regulate or control the power received through the battery pack interface 185 and to the controller 100. In some embodiments, the battery pack interface 185 is also coupled to the power switching network 155. The operation of the power switching network 155, as controlled by the controller 100, determines how power is supplied to the motor 180.

The current sensor 170 senses a current provided by the battery pack 190, a current associated with the motor 180, or a combination thereof. In some embodiments, the current sensor 170 senses at least one of the phase currents of the motor 180. The current sensor 170 may be, for example, an inline phase current sensor, a pulse-width-modulation-center-sampled inverter bus current sensor, or the like. The speed sensor 150 senses a speed of the motor 180. The speed sensor 150 may include, for example, one or more Hall effect sensors. In some embodiments, the temperature sensor 172 senses a temperature of the switching network 155, the battery pack 190, the motor 180, or a combination thereof. The input device 140 is operably coupled to the controller 100 to, for example, select a forward mode of operation, a reverse mode of operation, a torque setting for the power tool 10, and/or a speed setting for the power tool 10 (e.g., using torque and/or speed switches), etc. In some embodiments, the input device 140 may additionally select an operating mode to change the parameters of the motor 180. In some embodiments, the input device 140 includes a combination of digital and analog input or output devices required to achieve a desired level of operation for the power tool 10, such as one or more knobs, one or more dials, one or more switches, one or more buttons, etc. In other embodiments, the input device 140 is configured as a ring (e.g., torque ring), a dial 32, a knob, a multi-position switch, etc. In some embodiments, the input device 140 interfaces with a circuit board via sensing portions 158 (e.g., a trigger sensing portion, mode selection portion, and a dial sensing portion) configured to sense changes to a combination of input devices 140 and the trigger 28. In the embodiment shown, control of the input devices 140 sets a desired operational characteristic the motor 180 (e.g., speed of the motor 180, torque of the motor 180, motor rotational direction, etc.).

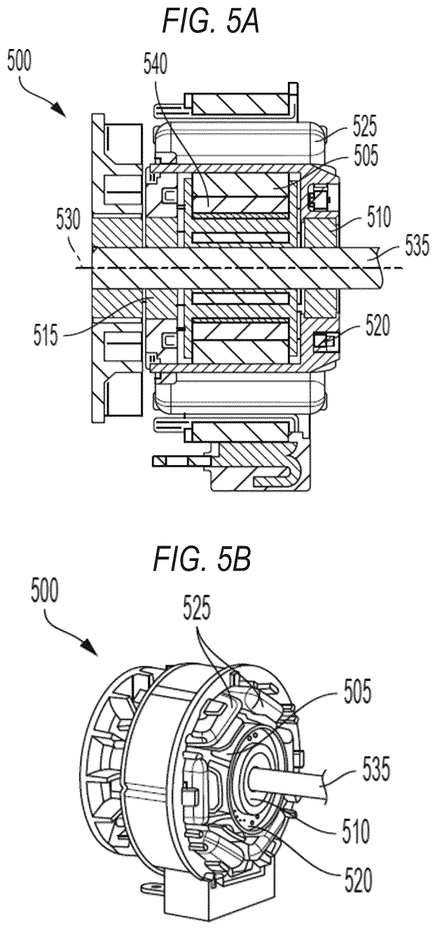

FIGS. 5A and 5B illustrate an exemplary BLDC motor 500 housed in the the power tool 10. The motor 500 is similar to motor 180 and is controlled by the controller 100 in the same way as the motor 180. The motor 500 includes a rotor 505, a front bearing 510, a rear bearing 515 (collectively referred to as the bearings 510, 515), a position sensor board assembly 520 within a stator envelope of the motor 500 and a motor shaft 535. Stator coils 525 are parallel to the length of a rotor axis 530. Rotor magnets 540 are brought into proximity of the Hall effect sensors on the position sensor board assembly 520 in order to detect the rotor position. Recessing the rotor 505, the bearings 510, 515, and the position sensor board assembly 520 within the stator envelope allows a more compact motor in the axial direction.

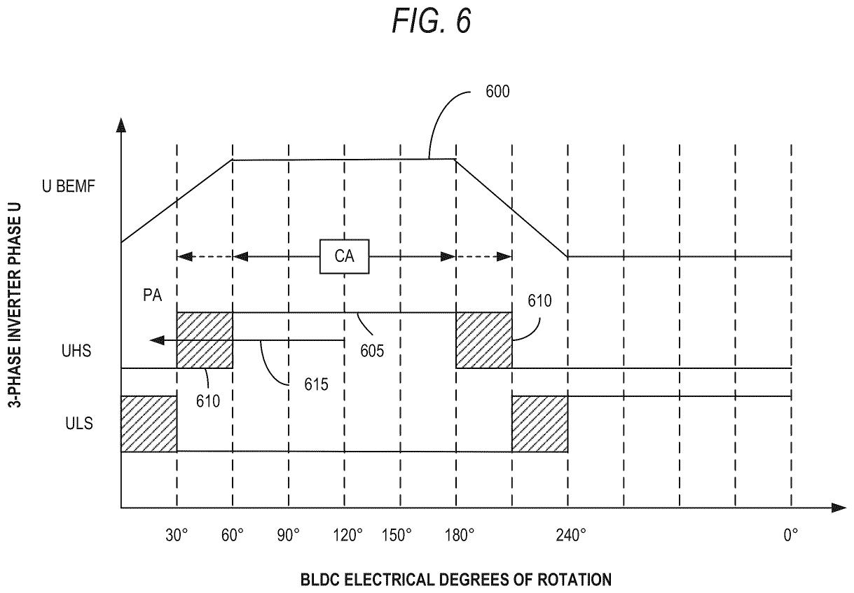

FIG. 6 is a graph 600 illustrating commutation applied to the motor 500 in the power tool 10. In some embodiments, the conduction angle of the motor 500 may be varied to increase or decrease the conduction angle. Generally, a conduction angle applied to a BLDC motor (e.g., the motor 180, 500) is set to a default value (e.g., approximately 105°, approximately 120°, between 90° and 120°, etc.). However, the conduction angle for a given phase may be increased up to a maximum value, such as 180°. Increasing the conduction angle allows for more current to flow through the motor windings for a longer duration, resulting in higher torque production and is beneficial for maintaining motor performance at higher speeds. However, increasing the amount of current flowing through the motor 500 may result in larger resistive losses, and therefore be less efficient. As shown in FIG. 6, the conduction angle may generally be 120° and applied to either a high side switch (such as high side FETs) or low side switches (such as low side FETs), in order to drive the motor 500. As further shown in FIG. 6, the conduction angle 605 may be increased (as shown by optional conduction regions 610) from 120° to a maximum value, such as 180°. Further, as noted above, the conduction angle 605 may additionally or alternatively be shifted to occur earlier in the conduction cycle (i.e., phase advance), as shown by phase advance line 615. Generally, a phase advance applied to a BLDC motor (e.g., the motor 180, 500) allows the motor to achieve higher speeds by aligning the current waveform with the motor's back EMF, which may weaken the magnetic field of the motor. As a result, a phase advance applied to a BLDC motor 500 may reduce the motor's torque output and may allow the motor 500 to operate at higher speeds with a reduced torque output. Additionally, applying a phase advance can increase the current drawn by the motor 500 due to increasing the current ripple, thereby increasing the amount of power consumed by the motor. Similarly, conduction angle slope can be controlled. Conduction angle slope determines the speed at which the motor transitions into a field weakening mode. A steeper slope means that the motor starts weakening the field at lower speeds, which provides a broader speed range and higher operational speeds. Accordingly, it may be beneficial to finely control the commutation applied to the motor 500 to achieve dynamically configurable motor parameter (DCMP) to meet the requirements of a particular task or a particular operational mode at the highest efficiency.

In some embodiments, the controller 100 may use a single field weakening methodology or a combination of field weakening methodologies to control the motor 500 of the power tool 10. In some embodiments, the controller 100 may vary the application of at least one field weakening methodology based on a motor parameter setting (e.g., a setting required for a given task). In some embodiments, the controller 100 may vary a combination of at least one field weakening methodology and the apparent power applied to the motor 500 of the power tool 10.

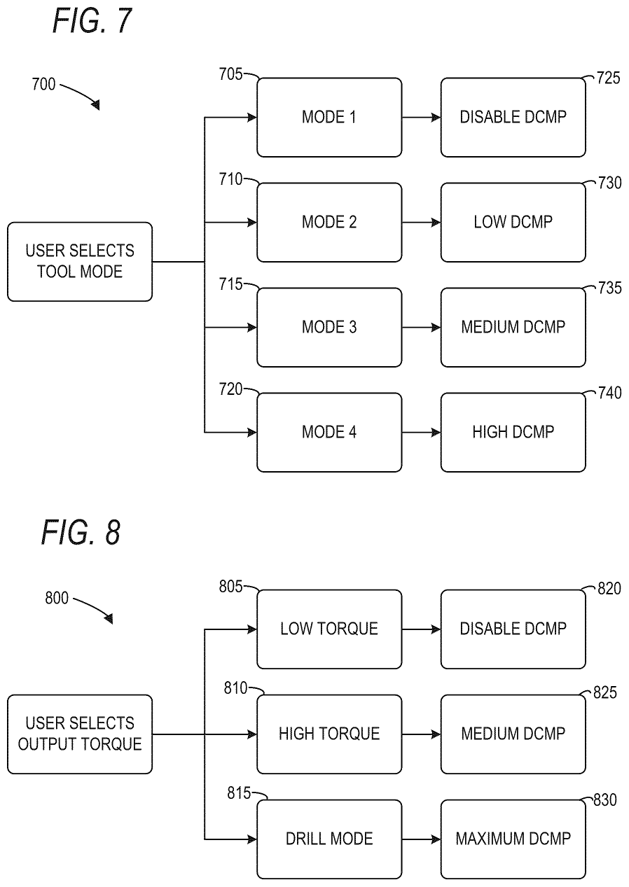

FIGS. 7-8 are flow charts 700, 800 of exemplary control methods for controlling the commutation of the motor 180, 500 to adjust the operating parameters and therefore output of the motor 180, 500. Although the illustrated methods 700, 800 include a number of exemplary modes, not all of the modes need to be implemented as illustrated. Furthermore, in some embodiments, some methods may include additional selectable modes to allow for greater control over the field weakening applied to the motor 180, 500. For example, the power tool 10 can include at least two selectable modes that correspond to different commutation profiles for the power tool 10 (e.g., each mode corresponding to a set conduction angle, phase advance, conduction angle slope, maximum speed, pulse-width modulated [“PWM”] duty cycle, etc.). In some embodiments, any number of selectable modes having different commutation profiles can be included in the power tool 10 (e.g., five modes, ten modes, twenty modes, etc.). In some embodiments, as a tool parameter setting increases (e.g., desired motor torque), values for motor parameters (e.g., conduction angle, phase advance, conduction angle slope, maximum speed, pulse-width modulated [“PWM”] duty cycle, etc.) also increase between minimum and maximum values. In some embodiments, the conduction angle can have any value between 90 degrees and 180 degrees. In some embodiments, the phase advance angle can have any value between zero and 90 degrees.

With reference to the exemplary flow chart 700 of FIG. 7, a user can select a first tool mode 705, a second tool mode 710, a third tool mode 715, and a fourth tool mode 720. Each mode corresponds with a different motor commutation using DCMP.

Table 1 below illustrates exemplary values to demonstrate the changes in the commutation applied to the motor 500 based on a user input. In other embodiments, the specific commutation applied in a specific tool mode or the change in commutation applied between tool modes may be different.

In some embodiments, setting a power tool to the first tool mode 705 disables DCMP (at block 725), resulting in the conduction angle applied to the motor 500 being unchanged (e.g., a default value), and a phase advance angle is not applied (i.e., zero degrees). The second tool mode 710 allows for a low amount of DCMP (at block 730), resulting in an increase of the max conduction angle to 122 degrees without applying a phase advance (i.e., zero degrees). The third tool mode 715 allows for a medium amount of DCMP (at block 735), resulting in an increase of the max conduction angle (e.g., to 125 degrees) and applying a phase advance angle (e.g., of 2 degrees). The fourth tool mode 730 allows for a high amount of DCMP (at block 740), resulting in an increase of the max conduction angle (e.g., to 140 degrees) and applying a phase advance angle (e.g., of 8 degrees). In some embodiments of the first tool mode 705, the second tool mode 710, the third tool mode 715, and the fourth tool mode 740, the maximum speed, set torque, conduction angle slope, power, etc., may additionally be limited or otherwise controlled in addition to controlling the conduction angle and phase advance angle as motor parameters.

TABLE 1

| Tool Mode | RPM Limit (%) | MAX_CA (in °) | PA (in °) |
|---|---|---|---|
| 1 | 33 | 120 | 0 |
| 2 | 50 | 122 | 0 |
| 3 | 66 | 125 | 2 |
| 4 | 100 | 140 | 8 |

With reference to the exemplary flow chart 800 of FIG. 8, a user can select a low torque mode 805, a high torque mode 810, and a drill mode 815. Each mode corresponds with a different motor commutation using DCMP based of a torque mode or setpoint. For example, in low torque applications it may not be necessary to increase the max output torque of the motor 180, 500.

Table 2 below illustrates exemplary values to demonstrate the changes in the commutation applied to the motor 180, 500 based on a user input. In other embodiments, the specific commutation applied in a specific torque setting or the change in commutation applied between torque settings may be different. Furthermore, the torque modes 805, 810, 815 may not correspond with any specific values exemplified in Table 2.

In some embodiments, setting the power tool 10 to a low torque mode 805 may disable DCMP (at block 820), resulting in the conduction angle applied to the motor 500 being unchanged (e.g., a default value), and a phase advance angle is not applied (i.e., zero degrees). The high torque mode 810 may enable a medium amount of DCMP, resulting in an increase of the max conduction angle (e.g., to 125 degrees) and applying a phase advance (e.g., of 2 degrees). The drill mode 815 allows for a maximum amount of DCMP (at block 830), resulting in an increase of the max conduction angle (e.g., to 140 degrees) and applying a greater phase advance (e.g., of 20 degrees). In some embodiments of the torque modes 805, 810, 810, the maximum speed, set torque, conduction angle slope, power, etc., may additionally be limited or otherwise controlled in addition to controlling the conduction angle and phase advance angle as motor parameters.

TABLE 2

| Torque Setting | Torque Setpoint (in-lbs) | MAX_CA (in °) | PA (in °) |
|---|---|---|---|
| 1 | 8 | 120 | 0 |
| 2 | 10 | 122 | 1 |
| 3 | 15 | 125 | 2 |
| 4 | 30 | 130 | 8 |
| 5 | 35 | 133 | 12 |
| 6 | 40 | 135 | 15 |
| DRILL | MAX | 140 | 20 |

In some embodiments, DCMP can be automatically applied by the power tool 10 (e.g., independent of a user input setting). In such situations, the DCMP can be dynamically controlled based on a parameter of the power tool 10 (e.g., a measured torque, a measured speed, a measured load [e.g., current, power, etc.], an amount of trigger depression, etc.). In some embodiments, increases or decreases in a measured load of the power tool 10 can cause DCMP to be enabled, disabled, or modified (e.g., similar to Table 1 and Table 2 above).

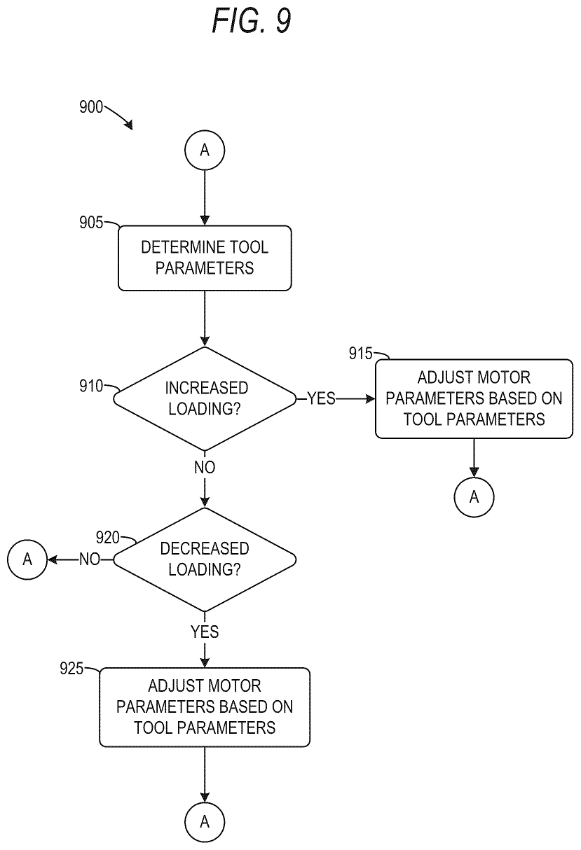

FIG. 9 illustrates a flowchart 900 for an exemplary method of automatically controlling the motor parameters (e.g., conduction angle, phase advance angle, etc.) based on a tool parameter (e.g., a torque setting, a measured torque, a speed setting, a measured speed, an amount of trigger depression, a measured load, etc.). More specifically, upon activating the tool, the controller 100 determines a tool parameter (at block 905). The tool parameter may be a power tool load (e.g., current, power, etc.), a power tool speed setting, a power tool torque setting, or another operating parameter of a power tool. Using the tool parameter, the controller 100 determines if a motor parameter (e.g., conduction angle, phase advance angle, etc.) should be adjusted (at blocks 910, 920) based on the tool parameter, and adjusts the motor parameters (at blocks 915, 925) upon determining to change the motor parameters. In some embodiments, the controller 100 may determine if the loading of the motor should be increased and increases the DCMP applied to the motor upon determining that the loading of the motor should be increased (block 915). Conversely, the controller 100 may determine if the loading of the motor should be decreased, and decreases or disables the DCMP applied to the motor upon determining that the loading of the motor should be decreased (block 925). The DCMP can be adjusted as similarly described above with respect to Table 1 and Table 2.

Additionally or alternatively, DCMP can be controlled (e.g., enabled, disabled, modified, etc.) based on additional conditions of the power tool. For example, DCMP can be automatically controlled only when a user selects DCMP to be enabled. In some embodiments, DCMP can be enabled based upon a power tool condition (e.g., trigger fully pulled, trigger pulled a threshold amount, etc.). Once DCMP is enabled, the level of DCMP (e.g., conduction angle, phase advance angle, etc.) can be controlled based on a parameter of the power tool 10 (e.g., power tool load, current draw, etc.) with respect to one or more settings or thresholds (e.g., a load threshold, a power threshold, a current threshold, etc.). Such dynamic control does not seek to achieve a set or particular motor parameter (e.g., conduction angle, phase advance angle, etc.). Rather, the power tool 10 controls DCMP to provide additional power when warranted by the conditions of the power tool 10.

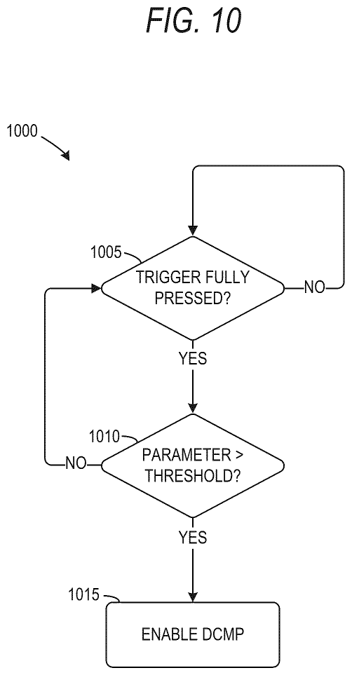

FIG. 10 illustrates a flowchart 1000 for a method of determining when to enable DCMP. In some embodiments, DCMP may be completely disabled except under specific conditions. In some embodiments, DCMP may have a different number of conditions before being enabled.

At block 1005, the controller 100 determines if the trigger 28 is fully pressed. In some embodiments, the controller 100 may determine if a different trigger threshold is met (e.g., 50%, 75%, etc.). In some embodiments, the controller 100 may determine if a different input device 140 is actuated (e.g., a user input to selectively enable DCMP, a forward/reverse switch, a speed setting, a torque setting, etc.).

At block 1010, the controller 100 determines if a parameter is greater than a threshold value. In some embodiments, the parameter may be time and the threshold may be a delay of, for example, 2 seconds. In other words, the trigger 28 would have to be fully pressed for over 2 seconds in order to enable DCMP. In other embodiments, the parameter and threshold may encompass temperature, motor load (e.g., current, power, etc.), battery pack state of charge, or another parameter indicating a status of the power tool.

At block 1015, upon determining that the trigger is fully pressed and that a parameter is greater than a threshold, DCMP is enabled. The DCMP can be automatically adjusted by the controller 100 as similarly described above with respect to Table 1 and Table 2.

Thus, embodiments described herein provide, among other things, a power tool including a circuit board having multiple sensors configured to sense the positions of various input devices. Various features and advantages are set forth in the following claims.

What is claimed is:

1. A power tool comprising:
a housing;
a brushless motor supported within the housing, the brushless motor including a rotor and a stator, the brushless motor configured to rotate a motor shaft to produce an output, the output of the brushless motor being adjustable based on a plurality of selectable field weakening modes;
a battery pack receptacle configured to receive a battery pack;
a power circuit configured to receive power from the battery pack and supply power to the brushless motor; and
an electronic processor electrically connected to the power circuit, the electronic processor configured to:
determine a tool parameter associated with the output of the power tool,
determine a motor parameter based on the determined tool parameter, the motor parameter being associated with one of the plurality of selectable field weakening modes, and
control the brushless motor using the one of the plurality of selectable field weakening modes.

2. The power tool of claim 1, further comprising:
a user input configured to select among the plurality of selectable field weakening modes.

3. The power tool of claim 2, further comprising:
an indicator configured to provide an indication of the one of the plurality of selectable field weakening modes.

4. The power tool of claim 1, wherein the tool parameter is a power tool load.

5. The power tool of claim 4, further comprising:
a sensor configured to generate a sensor signal,
wherein the electronic controller is further configured to receive the sensor signal from the sensor, and
wherein the tool parameter is determined based on the sensor signal.

6. The power tool of claim 1, wherein the motor parameter is a conduction angle.

7. The power tool of claim 1, wherein the motor parameter is a phase advance angle.

8. The power tool of claim 1, wherein the tool parameter is a torque setting.

9. A power tool comprising:
a housing;
a brushless motor supported within the housing, the brushless motor including a rotor and a stator, the brushless motor configured to rotate a motor shaft to produce an output, the output of the brushless motor being adjustable based on a motor parameter;
a battery pack receptacle configured to receive a battery pack;
a mode input device disposed on the housing, the mode input device configured to receive a user input indicative of a tool mode;
a power circuit configured to receive power from the battery pack and supply power to the brushless motor; and
an electronic processor electrically connected to the mode input device and the power circuit, the electronic processor configured to:
receive a tool mode from the mode input device,
determine a commutation profile in response to the tool mode received by the mode input device,
determine an adjusted motor parameter based on the commutation profile, and
control the brushless motor using the adjusted motor parameter.

10. The power tool of claim 9, wherein the adjusted motor parameter is a conduction angle.

11. The power tool of claim 9, wherein the adjusted motor parameter is a phase advance.

12. The power tool of claim 9, wherein the housing further includes a motor housing portion, a front housing portion, a rear housing portion, and a handle extending from the motor housing portion.

13. The power tool of claim 12, further comprising:
a set of indicators disposed on the rear housing portion, the set of indicators configured to produce an indication associated with the tool mode.

14. The power tool of claim 9, wherein the electronic processor is further configured to:
determine a maximum speed based on the tool mode received by the mode input device, and
control the brushless motor using the maximum speed.

15. A power tool comprising:
a housing including a motor housing portion, a front housing portion, a rear housing portion, and a handle extending from the motor housing portion;
a brushless motor supported within the motor housing portion, the brushless motor including a rotor and a stator, the brushless motor configured to rotate a motor shaft to produce an output, the output of the brushless motor being adjustable based on a plurality of selectable field weakening modes;
a battery pack receptacle disposed on the handle, the battery pack receptacle configured to receive a battery pack;
a mode input device disposed adjacent to the battery pack receptacle, the input device configured to receive a user input indicative of one of the plurality of selectable field weakening modes;
an indicator configured to provide an indication of the one of the plurality of selectable field weakening modes;
a power circuit configured to receive power from the battery pack and supply power to the brushless motor; and
an electronic processor electrically connected to the input device and the power circuit, the electronic processor configured to:
determine a tool parameter associated with the output of the power tool,
determine a motor parameter based on the determined tool parameter, the motor parameter being associated with one of the plurality of selectable field weakening modes, and
control the brushless motor using the one of the plurality of selectable field weakening modes.

16. The power tool of claim 15, wherein the motor parameter is a conduction angle.

17. The power tool of claim 15, wherein the motor parameter is a phase advance angle.

18. The power tool of claim 15, wherein the tool parameter is a torque setting.

19. The power tool of claim 15 further comprising:
a trigger coupled to a front side of the handle.

20. The power tool of claim 19, wherein the electronic processor is further configured to:
determine whether the trigger is pressed beyond a threshold;
disable the control of the brushless motor using the one of the plurality of selectable field weakening modes upon determining that the trigger is not pressed to or beyond the threshold, and
enable the control of the brushless motor using the one of the plurality of selectable field weakening modes upon determining that the trigger is pressed to or beyond the threshold.
